(19) United States
(12) Patent Application Publication
(10) Pub. No.: US 2003/0023559 A1
(43) Pub. Date: Jan. 30, 2003

(54) Method for securing digital information and system therefor

(76) Inventors: Jong-Uk Choi, Seoul (KR); Won-Ha Lee, Seoul (KR); Jung-Seok Cho, Kyunggi-do (KR); Wan-Ho Jang, Kyunggi-do (KR); Ji-Sun Seo, Seoul (KR)

Correspondence Address: MARSHALL, GERSTEIN & BORUN, 6300 SEARS TOWER, 233 SOUTH WACKER, CHICAGO, IL, 60606-6357, US

(21) Appl. No.: 10/034,485

(22) Filed: Dec. 28, 2001

(30) Foreign Application Priority Data
Jul. 30, 2001 (KR) 2001-45856

(51) Int. Cl. H04K 1/00

(52) U.S. Cl. 705/51

(57) ABSTRACT

A digital information security system is disclosed. A user application tool installed in a user terminal, creates a unique user key using unique system information of the user terminal. A data storage unit stores user information and digital information. A user management tool installed in a server, receives the unique user key created by the user application tool, stores the received unique user key in the data storage unit as part of the user information, and compares, during user authentication, the stored unique user key with a unique user key provided from the user application tool of a user currently being subjected to authentication.

### PRIORITY

This application claims priority to an application entitled “Method for Securing Digital Information and System Therefor” filed in the Korean Industrial Property Office on Jul. 30, 2001 and assigned Serial No. 2001-45856, the contents of which are hereby incorporated by reference.

### BACKGROUND OF THE INVENTION

1. Field of the Invention

The present invention relates generally to methods and apparatus for preventing an unauthorized user from fraudulently copying confidential digital information (e.g., a program, an application, a database, a document file, etc.) stored in a host computer and distributing the information through wire/wireless communication or a recoding medium such as a floppy diskette, and in particular, to a methods and apparatus for preventing a user from illegally using digital information shared in a company or other institution.

2. Description of the Related Art

Information such as documents and data may be digitalized by a computer, and the digital information can then be easily distributed through the Internet or a digital recording media such as a disk. Once the information is in digital form, a person can easily make a duplicate copy or a modified copy of the original work, and illegally distribute the copy. Information leakage through such illegal distribution may cause great damage to a company or a public institution.

In particular, as the LAN (Local Area Network) and KMS (Knowledge Management System) systems are constructed in most companies to facilitate information sharing in the company, users can more easily access the digital information, increasing the possibility of information leakage. Actually, there are an increasing number of the cases that the staffs of a company illegally leak the confidential information of the company, when they leave the company or move to another company.

Accordingly, there is an increasing demand for a digital information security technique. To meet the demand, there have been developed various security techniques for preventing the illegal use and distribution of the information. Such security techniques include a firewall installation technique, a digital rights management (DRM) technique for securing and managing digital documents, and an E-mail user restriction technique.

The firewall installation technique for system security, network security and facility security, is a technique for chiefly preventing illegal invasion from the outside. Since this technique is aimed at preventing invasion from the outside rather than managing the users of the company or the institution, typically, it does not prevent invasion from the inside.

The DRM technique is a technique for preventing illegal copying and distribution of multimedia information, allowing only authorized users to use the information, and managing a copyright of the multimedia information through a billing service. Although the DRM technique is considered a realistic solution capable of protecting and managing a copyright of the digital information in the current market, the existing DRM system is very complex in structure and large in size, making it difficult for the user to implement the service.

In most cases, the DRM service provider manages authentication keys which are necessary when a user reproduces the purchased information. In such an instance, the user transmits the information to a server register for registration and encryption and then receives the information that is actually used. Accordingly, when the DRM system is used in the company or the public institution, the user should perform a double operation of sending the information to the server register and then receiving the information for management of the information, complicating the information transmission route. As a result, there is a possibility that the information will be leaked during transmission.

Further, in the case of the DRM technique, once the information is decrypted, the source contents are likely to be distributed more easily. When such a DRM technique is applied to document management, it is necessary to send the documents to be secured to the server registrar for encryption, receive the encrypted documents and then distribute the received encrypted documents. Therefore, it is cumbersome to apply the DRM technique.

### BRIEF DESCRIPTION OF THE DRAWINGS

The above features and advantages of the present invention will become more apparent from the following detailed description of certain embodiments when taken in conjunction with the accompanying drawings in which:

FIG. 1 is a schematic block diagram illustrating a structure of a digital information security system according to an embodiment of the present invention;

FIG. 2 is a detailed block diagram illustrating structures of the digital information server and the user terminal of FIG. 1;

FIG. 3 is a flow chart illustrating a user registration process by the digital information server according to an embodiment of the present invention;

FIG. 4 is a flow chart illustrating a process for uploading a digital file from a user to the digital information server according to an embodiment of the present invention;

FIG. 5 is a flow chart illustrating a process for downloading a digital file i from the digital information server to the user terminal according to an embodiment of the present invention;

FIG. 6 is a schematic block diagram illustrating a structure of a digital information security system according to an embodiment of the present invention;

FIG. 7 is a block diagram illustrating an operation of the user information key management service module of FIG. 6;

FIG. 8 is a diagram illustrating an operation of the digital information management service gateway of FIG. 6;

FIG. 9 is a diagram illustrating an operation of the digital information distribution service module of FIG. 6;

FIG. 10 is a diagram illustrating an exemplary operator interface screen displayed by a user management tool in the digital information security system according to an embodiment of the present invention;

FIG. 11A is a diagram illustrating an exemplary screen for vesting every user in a certain department with all the authorities in a management tool interface screen of FIG. 10;

FIG. 11B is a diagram illustrating an exemplary screen displaying a state where every user in the certain department is vested with all the authorities;

FIG. 12A is a diagram illustrating an exemplary screen for adding a new department in the management tool interface screen of FIG. 10;

FIG. 12B is a diagram illustrating an exemplary screen displaying a state where a new department is added in the management tool interface screen of FIG. 10;

FIG. 13A is a diagram illustrating an exemplary screen for changing user information of a specific user in the management tool interface screen of FIG. 10;

FIG. 13B is a diagram illustrating another exemplary screen for changing user information of a specific user in the management tool interface screen of FIG. 10;

FIG. 14A is a diagram illustrating an exemplary output screen displayed when a user not having a digital file save authority attempts to save the document;

FIG. 14B is a diagram illustrating an exemplary output screen displayed when a user not having a print authority attempts to print the document; and

FIG. 15 is a diagram illustrating an exemplary screen displayed when a digital file downloaded according to an embodiment of the present invention is copied or opened in another system.

### DETAILED DESCRIPTION OF EXEMPLARY EMBODIMENTS

Embodiments of the present invention are described below with reference to the accompanying drawings. In the following description, well-known functions or constructions are not described in detail since they would obscure the embodiments in unnecessary detail.

Digital information security methods and apparatus are disclosed. The methods and apparatus apply to the overall process of creating digital information (e.g., company documents) to be secured, distributing the digital information to users through a network or a certain off-line route, and discarding the company documents. The methods and apparatus include a management system for preventing users from fraudulently using and forging the digital information by vesting the users with an authority to use the digital information.

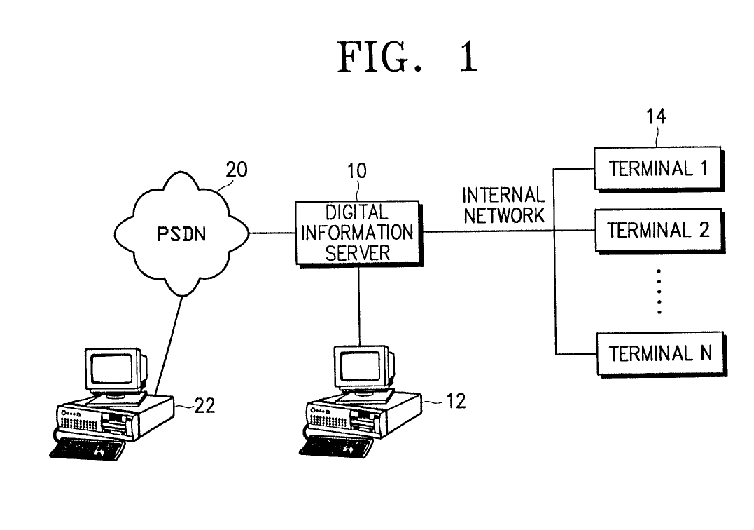

FIG. 1 illustrates a structure of a digital information security system according to an embodiment of the present invention. Referring to FIG. 1, a digital information server 10 is connected to a plurality of user terminals (or personal computers) 14 through an internal network, and is also connected to a plurality of remote users through a PSDN (Packet Switched Data Network) 20, which is a data communication network. The digital information server 10 is a system for uploading digital files, managing the digital files and providing users and companies with the digital files.

The digital information server 10, connected to a host computer 12, sets up various options of a digital information security operation according to commands received from the host computer 12. A server manager manages the digital information server 10 through the host computer 12, to control the information security operation.

The remote user can access the digital information server 10 via the PSDN 20 using a personal computer (PC) 22. The personal computer 22 can be provided with the company information encrypted according to the present invention from the digital information server 10 through the PSDN 20. Alternatively, the personal computer 22 can also be connected to the digital information server 10 through a LAN (Local Area Network) or a WAN (Wide Area Network). It will be assumed herein that the PSDN 20 includes the LAN and the WAN.

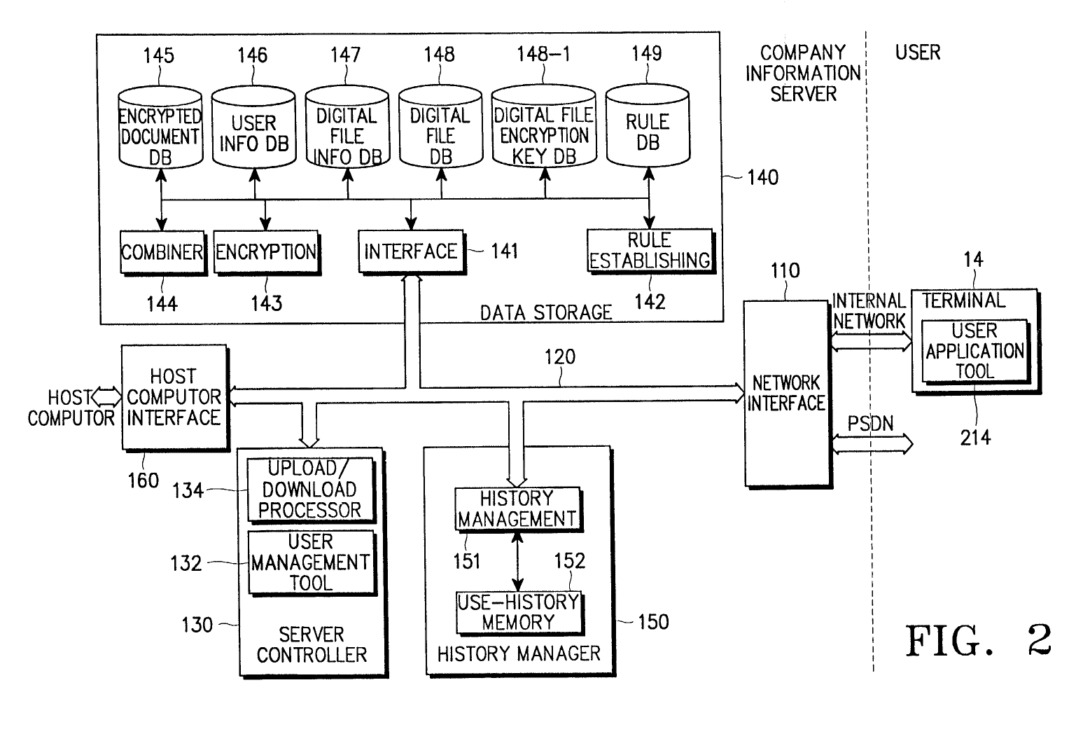

A digital information security application tool is installed in the user terminals 14 and the personal computer 12, which are provided with the encrypted company information from the digital information server 10 through the internal network and the PSDN 20, respectively. The digital information server 10 manages information on the users of the user terminals 14 and the personal computer 22, and has a management tool for encrypting and managing digital files, and a database (DB) for storing various data. A detailed description of the company information server 10 will be given with reference to FIG. 2. The digital information security system can be operated in connection with normal document management system or knowledge management system.

FIG. 2 illustrates detailed structures of the digital information server 10 and the user terminal 14 connected thereto, shown in FIG. 1. In one embodiment, the digital information server 10 includes a network interface 110, a data communication path 120, a server controller 130, a data storage unit 140, a history manager 150, and a host computer interface 160.

The network interface 110, connected to the PSDN 20 and the internal network, provides data received from the user terminal 14 and the user computer 22 to the data communication path 120, and provides data received from the data communication path 120 to the personal computer 22 and the user terminal 14 through the PSDN 20 and the internal network, respectively.

The data communication path 120 can be implemented in different ways. For example, when the function blocks of the digital information server 10 are united into one system, the data communication path 120 can be implemented with a data bus for transmitting data to the respective function blocks. As another example, when the function blocks serve as independent systems, the data communication path 120 can be implemented with a LAN for connecting the function blocks to one another. In addition, when the function blocks constitute several independent systems and the function blocks in each independent system are internally connected, the independent systems are connected to one another via a LAN, and the function blocks in each independent system are connected with one another via a data bus.

The server controller 130 controls the overall operation of the digital information server 10. In particular, the server controller 130 performs a process for displaying initial access screen information and accessible documents. In addition, the server controller 130 provides information for processing bulletin board information and operator mail information, which may not require the security function. Besides, the server controller 130 controls a user authentication operation and a digital file upload/download operation at a user's request for encryption of the company documents and a user's request for access to the company documents. The server controller 130 includes a user management tool 132 for managing an encryption key and a unique user key.

The data storage unit 140 includes an interface 141, a rule establishing unit 142, an encryption unit 143, a combiner 144, an encrypted document DB 145, a user information DB 146, a digital file information DB 147, a digital file DB 148 and a rule DB 149.

The interface 141 provides data received from the outside through the data communication path 120 to the function blocks and the databases in the data storage unit 140. Further, the interface 141 reads data from the databases and provides the data to the external function blocks through the data communication path 120. The rule establishing unit 142 establishes various rules on the users and the digital files according to various rule establishing factors registered in the rule DB 149. The digital file DB 148 stores digital files, the digital file information DB 147 stores digital file information, and the user information DB 146 stores user information including the unique user key information. The encryption unit 143 encrypts the information stored in the digital file DB 148, the digital file information DB 147 and the user information DB 146 in response to an encryption key input. The combiner 144 combines the digital files with their associated unique user keys, encryption keys and rules, encrypts the combined documents to be decoded with user unique key, and then stores the encrypted documents in the encrypted document DB 145. The encrypted files, encrypted decoding key and rules are combined and transmitted to the user. Although the encrypted document DB 145, the user information DB 146, the digital file information DB 147, the digital file DB 148 and the rule DB 149 are logically separated, they can be physically constructed into one database.

The history manager 150 may be divided into a history management device 151 and a use-history memory 152. The history management device 151 receives information on a information reading history provided from the network interface 110, classifies the received history information; and then stores the classified history information in, the use-history memory 152. Such history information may be valuable for documents having a high security class.

A user application tool 214 is preferably installed in the user terminal 14 with which the user writes and reads the company documents. The user application tool 214 creates a unique user key using an identifier (ID) of the user terminal (or user system) in which it is installed, and transmits the created unique user key to the digital information server 10.

In one embodiment, the user downloads the user application tool 214 from the digital information server 10 after a user registration process, and installs the downloaded user application tool 214 in the user terminal 14. The user application tool 214 creates the unique user key using the ID of the user terminal 14 where it is installed, and transmits the created unique user key to the digital information server 10, for user registration.

For authentication of using the digital information, the user application tool 214 provides various available conditions and the unique user key to the user management tool 132, and transmits information and signals meeting the conditions. Upon receipt of the unique user key information from the user application tool 214, the user management tool 132 receives various rule factors for controlling the company document files from the rule DB 149, and establishes the rules through the rule establishing unit 142. The unique user key information is stored in the user information DB 146.

The digital files uploaded by the user are encrypted and stored in the digital file DB 148, and this document is combined with a category of the company document established by the rule establishing unit 142, the user information, the unique user key and the company document encryption key by the combiner 144. The encrypted company documents are provided back to the user application tool 214 via the LAN, an off-line route, or the Internet through a web-based user password input process and a web-based user authentication process, so that the user can read the company documents.

The user application tool 214 and the user management tool 132 are disclosed in detailed in Korean patent application No. 2001-23562 filed by the applicant, the contents of which are hereby incorporated by reference.

Now, an operation of creating the unique user key by the user application tool 214 will be described in detail. The computer system (i.e., the user terminal 14) may include a CPU (Central Processing Unit), a RAM (Random Access Memory), a HDD (Hard Disk Drive) and other peripheral devices. The unique user key may be created using the unique information on the elements of the user terminal 14, and based on the created unique user key, the user authentication and the information reproduction are controlled.

More specifically, in the case of the CPU, a chip of Pentium III and over has a unique ID. In addition, the HDD has a maker ID (IDE) written in a physical sector of a master sector. The maker ID includes a name of the maker and a serial number and a type of the HDD. In some cases, the serial numbers used by a maker A and a maker B may be identical. The present invention extracts such unique system information and creates the unique user key based on the extracted unique system information.

The user application tool 214, having a function of blocking leakage of the unique system information, stores the extracted unique system information in a known black box and creates the unique user key using the unique system information. An algorithm for creating the unique user key can be embodied in various ways. For security, the created unique user key should not remain in a registry. Therefore, the user application tool 214 preferably decrypts the encrypted information by searching the unique user key at every information request of the user. The information authenticated by a specific user in the above process is redistributed to second and third users according to the rule established by the rule establishing unit 142, so that the information cannot be reused without authentication.

The created unique user key provided from the user information DB 146 is managed as information on the users using the system,. That is, the user management tool 132 manages information on the unique user key and the encryption key created for encryption of the digital information to be provided to the users.

After the authentication of using the digital information and the user authentication by the user management tool 132 at a user's information request, the user can download the encrypted company information. A fundamental function of the user management tool 132 is, to protect the information by encrypting the information to, prevent illegal, use and distribution of the information over the whole process of creating, distributing, using and discarding the digital information, thereby protecting copyrighted and/or secret information. Accordingly, only the user having a valid encryption key can decode the encrypted information. Even though the encrypted information has been illegally distributed, it is useless without the encryption key. In this manner, the information can be protected.

In particular, the system transmits a key for decoding the encrypted information to the user through the user application tool 214 to guarantee the information security, thereby preventing leakage of the key. Preferably, the encryption key has a length of 128 bits. For the encryption, commercialized encryption algorithms such as a Twofish encryption algorithm or a Blowfish encryption algorithm can be used.

The encrypted information is decrypted, when necessary, through authentication of the unique user key and the company document encryption key by the user application tool 214. For such information distribution and key authentication, the rule establishing unit 142 establishes the information use-related rule, which indicates a rule of distributing and using the information and an authority to distribute and use the information, but has no direct connection with protection of a copyright of the digital information. In this manner, it is possible to add or change a new rule for redistribution of the digital information. Of course, the user can only use the information according to the allowed rule.

Next, a user registration process and a company information upload/download process is described in detail with reference to the accompanying drawings.

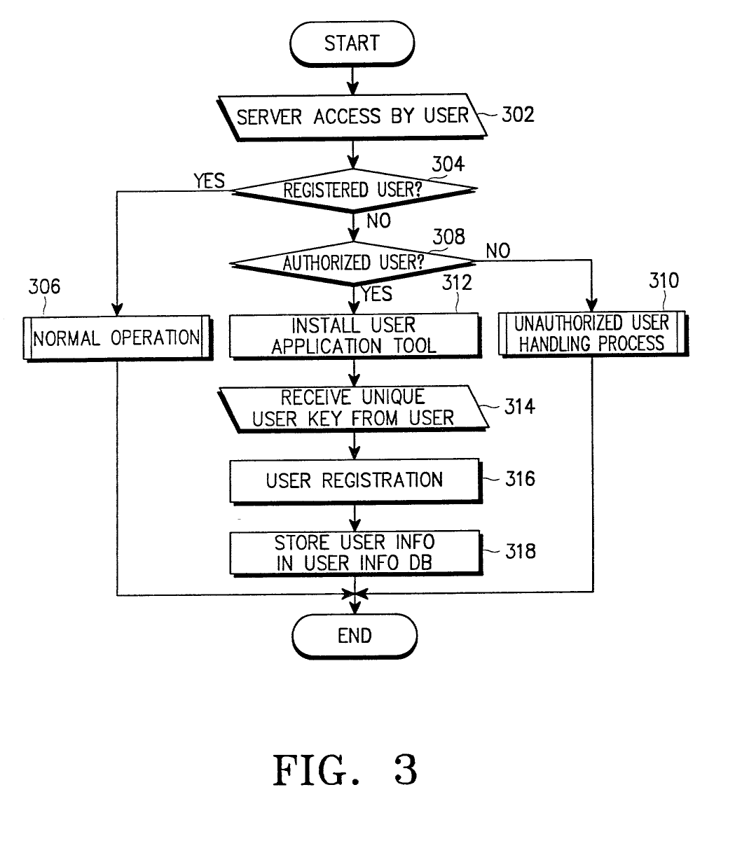

FIG. 3 illustrates a user registration process executed by the digital information server 10 and/or by another device according to an embodiment of the present invention. Preferably, the registration process is embodied in a software program. However, some or all of the steps of the process may be performed manually. Although the process is described with reference to the flowchart illustrated in FIG. 3, a person of ordinary skill in the art will readily appreciate that many other methods of performing the acts associated with process may be used. For example, the order of many of the steps may be changed without departing from the scope or spirit of the present invention. In, addition, many of the steps described are optional, and additional steps may be performed between the illustrated steps.

Referring to FIG. 3, if the user accesses the digital information server 10 in step 302, the digital information server 10 determines in step 304 whether the corresponding user is a registered user by checking whether the user application tool 214 is installed in the user terminal 14. If the user is a registered user, the digital information server 10 performs a normal operation in step 306. Otherwise, if the user is not a registered user, the digital information server 10 performs a procedure for authenticating whether the corresponding user is an authorized user in step 308. If the user is not an authorized user, the digital information server 10 performs a process for handling an unauthorized user in step 310. However, if the user is an authorized user, the digital information server 10 installs the user application tool 214 in the user terminal 14 in step 312. When installed in the user terminal 14, the user application tool 214 reads the unique information of the user terminal 14, creates a unique user key using the read information, and then transmits the created unique user key to the user management tool 132. Upon receipt of the unique user key from the user in step 314, the digital information server 10 registers the corresponding user in step 316 and then stores the user information including the unique user key for the registered user in the user information DB 146 in step 318. The user information is encrypted by a predetermined encryption algorithm before being stored in the user information DB 146, so that the user information cannot be interpreted even if it is leaked.

In one embodiment of the present invention, the user installs the user application tool 214 and transmits the unique user key to the digital information server 10 in order to register the unique user key through PSDN 20. If the user is an unregistered user of the service, the user registration process is performed by the user to access digital information server 10 through PSDN 20 as illustrated in FIG. 3. In the user registration process, the digital information server 10 downloads the user application tool 214 from the user management tool 132 and installs the downloaded user application tool 214 in the user terminal 14. The unique user key for the registered user, e.g., personal information of the user and/or information on the user terminal 14, is transmitted to the user management tool 132 through the LAN or the Internet, and then stored in the user information DB 146 after encryption.

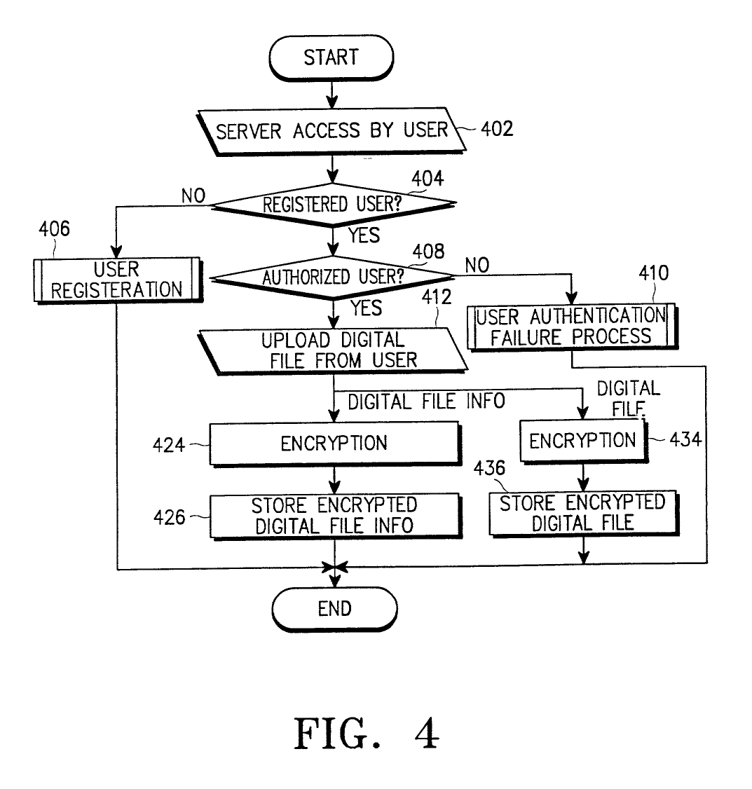

FIG. 4 illustrates a process for uploading the digital files from the user to the digital information server 10 according to an embodiment of the present invention. Preferably, the process is embodied in a software program. However, some or all of the steps of the process may be performed manually. Although the process is described with reference to the flowchart illustrated in FIG. 4, a person of ordinary skill in the art will readily appreciate that many other methods of performing the acts associated with process may be used. For example, the order of many of the steps may be changed without departing from the scope or spirit of the present invention. In addition, many of the steps described are optional, and additional steps may be performed between the illustrated steps.

Referring to FIG. 4, if the user accesses the digital information server 10 in step 402, the server controller first searches use history of history manager 150. If there is no user registration, the digital information server 10 performs the user registration process of FIG. 3 in step 406. Otherwise, if the user application tool 214 is installed in the user terminal 14, the digital information server 10 reads in step 408 the unique user key and compares the unique user key with the associated user information stored in the user information DB 146, to determine whether the user is authenticated (i.e., authorized) for the user terminal 14. If the user is not authenticated for the user terminal 14, the digital information server 10 performs a user authentication failure operation in step 410. However, if the user is authenticated for the user terminal 14, the digital information server 10 allows the user to upload documents in step 412. Through the user authentication, the digital information server 10 controls a subsequent operation of searching, displaying and downloading the company documents according to the user authority. The digital files uploaded by the user are classified into digital file information and digital files, which are separately encrypted in steps 424 and 434, respectively, and then, stored in the user in digital file information DB 147, and the digital file DB 148 in steps 426 and 436, respectively. Preferably, the digital information server 10 creates a separate encryption key for the digital file and encrypts the digital file using the created encryption key.

An operation of processing the uploaded digital files after user authentication is described in detail below. When documents are uploaded to the upload/download processor 134 in the server controller 130 of FIG. 2, the upload/download processor 134 provides information on the uploaded information to the encryption unit 143. The encryption unit 143 then reads the uploaded information by accessing a position where the digital files are actually uploaded, based on the provided information. Further, the encryption unit 143 creates separate keys (e.g., 128-bit encryption keys) for the respective documents, and stores the created keys in-association with-the corresponding documents in its internal database 147, 148. The reason for previously encrypting the documents is (1) to minimize a system load due to the encryption during download of the documents by the user, (2) to maximize a processing speed by omitting the encryption process on the documents, and (3) to maintain the security of the documents even though they are distributed purposely or mistakenly. Thereafter, the encryption unit 143 stores the encrypted documents in a designated folder of the encrypted document DB 145. Subsequently, the encryption unit 143 informs the upload/download processor 134 of completion of the upload process, i.e., indicates that encrypting the files uploaded from the user is completed. In a embodiment using PSDN 20 illustrated in FIG. 4, when the user access LAN or web service, the user uploads digital files to digital information server 10 after installation of user application tool 214 and user authentication through user management tool 132. Digital file information is received through DB gate way (or the interface 141 of FIG. 2) and encrypted by the encryption unit 143, stored the encrypted digital information in the digital file DB 147. Digital files are encrypted by encryption unit 143 and stored in digital file DB 148. Thereafter, the encryption unit 143 informs the upload/download processor 134 of completion of the uploaded process.

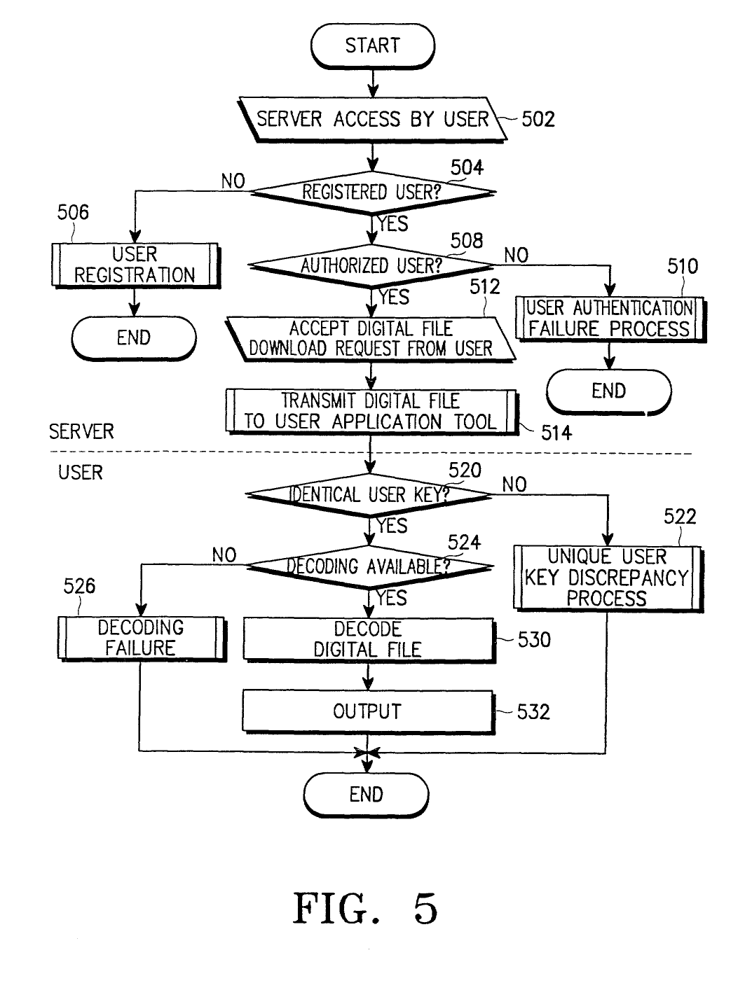

FIG. 5 illustrates a process for downloading the digital files from the digital information server 10 to the user terminal 14 according to an embodiment of the present invention. Preferably, the process is embodied in a software program. However, some or all of the steps of the process may be performed manually. Although the process is described with reference to the flowchart illustrated in FIG. 5, a person of ordinary skill in the art will readily appreciate that many other methods of performing the acts associated with process may be used. For example, the order of many of the steps may be changed without departing from the scope or spirit of the present invention. In addition, many of the steps described are optional, and additional steps may be performed between the illustrated steps.

Referring to FIG. 5, if the user accesses the digital information server 10 in step 502, the user management tool 132 determines in step 504 whether the user is registered by checking whether the user application tool 214 is installed in the user terminal 14. If the user application tool 214 is not installed in the user terminal 14, the digital information server 10 performs the user registration process of FIG. 3 in step 506. Otherwise, if the user application tool 214 is installed in the user terminal 14, the digital information server 10 reads in step 508 the unique user-key and compares the unique user key with the associated user information stored in the user information DB 146 and the history manager 150, to determine whether the user is authenticated (authorized) for the user terminal 14. If the user is not authenticated for the user terminal 14, the digital information server 10 performs a user authentication failure operation in step 510. However, if the user is authenticated for the user terminal 14, the digital information server 10 may accept a digital document download request from the user in step 512. The server controller 130 transmits a digital file decoding key from the digital file encryption key DB in data storage unit 140, encrypted information from digital file information DB 147 and rules from rule DB 149 to the combiner 144. The combiner 144 combines this transmitted information and creates a file after encrypting using the unique user key. Subsequently, use history is transmitted to the history manager 150. Here, according to the authority of user, operation of searching, displaying or downloading the digital documents are controlled. Thereafter, in step 514, the digital information server 10 transmits the corresponding company documents to the user application tool 214.

The user application tool 214 determines in step 520 whether a key used for encrypting the file downloaded from the digital information server 10 (e.g., a key used for encrypting a decoding key included in the downloaded file) is identical to the unique user key created by the user. Whether the keys are identical to each other can be determined by simply checking whether it is possible to decode the decoding key of the downloaded file with the unique user key created by the user. If they are not identical to each other, the user application tool 214 preferably performs a unique user key discrepancy operation in step 522. Otherwise, if they are identical to each other, the user application tool 214 preferably analyzes a decoding key included in the downloaded digital file in step 524, to determine whether the downloaded document can be decoded. If the downloaded file cannot be decoded, the user application tool 214 preferably performs a decoding failure process in step 526. However, if the downloaded file can be decoded, the user application tool 214 preferably decodes the digital file using the encryption key included in the corresponding digital file in step 530. Thereafter, in step 532, the user application tool 214 preferably outputs the decoded company document so that the user can read, edit and store the decoded company document.

Specifically describing the digital file download operation, if the user selects a specific file, information on the selected file is transmitted to the upload/download processor 133. The upload/download processor 134 then, provides the information on the selected file to the combiner 144. The combiner 144 physically accesses the encrypted file to be downloaded using the provided information, reads information on a unique user ID, a document key and a rule, and creates an encrypted download document file matched with a user authority in the user application tool 214. Thereafter, the combiner 144 stores the encrypted download document file in a download position. Upon completion of storing the encrypted download document file, the combiner 144 informs the upload/download processor 134 that an operation of storing the encrypted download document file is completed. The upload/download processor 134 is then provided with the encrypted download file by performing a general download process, and then, actually downloads the file to the user. The process is described in detail as follows.

At first, digital files (encrypted and stored previously) of digital file DB 148 requested by the user are transmitted to the combiner 144. Information on the unique user key, digital file decoding key and rules from user information DB 146 and rule DB 149 are transmitted to the combiner 144. The information is encrypted using unique user key and combined with encrypted digital files. These combined digital files and information are downloaded to the user. That is, the file requested by the user is encrypted and stored in the DB and combined with additional information, which is encrypted using the unique user key. The combined digital file is downloaded. Option ally, the information combined with encrypted digital file can be positioned at the head of the digital file.

Subsequently, the combiner 144 stores the downloaded file at the position of downloading. The combiner then informs the upload/download processor 134 that the operation has completed. The upload/download processor 134 stores use history of the operation at the history manager 150 and downloads the digital file to the user.

That is, the digital information server 10 inserts a header at the head of the encrypted document and then downloads the head-inserted document to the user. The header includes a key part for decoding the document encrypted with the encryption key and a rule information part for the user. This header part is encrypted and subsequently combined with digital files.

Prior to using the downloaded file, the user application tool 214 can decode the header using the unique user key created by the user. By decoding the header using the created unique user key, the user application tool 214 extracts the key for decoding the encrypted key and the rule information. In this manner, it is possible to decode the encrypted documents, and control a printing or, outputting operation according to the rule during execution of various applications.

Summarizing the process of FIG. 5, upon receipt of a request for specific digital information from the user, the user management tool 132 combines the encrypted digital file stored in the encrypted document DB 145 and digital file decoding key and rule information which is encrypted using unique user key and then transmits combined digital files, decoding key and rule information to the user application tool 214 for the corresponding user after the user authentication process. The encrypted digital file is transmitted through the LAN or the Internet at a user's request.

The user should perform a decoding process in order to reproduce (decode) the encrypted company document. In order to reproduce the information, an information decoding key is required, and the decoding key is preferably provided by encrypting the unique user key as stated above. By decoding the header using the created unique user key, the user application tool 214 extracts the key for decoding the encrypted key and the rule information. In this manner, it is possible to decode the encrypted documents, and control a printing or outputting operation according to the rule during execution of various applications.

Therefore, in order to reproduce the digital file transmitted to the user, it is important to determine whether it is possible to decode the file, because the requested file is transmitted after encryption. That is, in order to reproduce the file, a file decoding key is required and the decoding key is also transmitted to the user after encryption, so that a process for decoding this key should be performed previously.

In order to use the downloaded file, the unique user key is required. The key for decoding the encrypted information is extracted from the unique information on the user terminal 14 by the user application tool 214. That is, the user using the information encrypts the information decoding key by creating a unique user key with the unique information extracted from the system information, so that in order to decode this, a unique user key created from system information of another user should be identical to a key for encrypting the information decoding key. If the key for encrypting the encrypted digital document file decoding key is not identical to the unique user key, the user application tool 214 displays a message indicating that the user is not an authorized user, and then, ends the process. However, if the key for encrypting the encrypted digital file decoding key is identical to the created unique user key, the user application tool 214 can extract the file decoding key using the digital file decoding key encrypted with the unique user key. The digital file may then be decoded using the extracted file decoding key and company information may be reproduced using the user application tool 214.

The digital information distribution route preferably includes an on-line route using the wire/wireless communication and an off-line route as well. The present invention has been described with reference to an example in which the digital information is distributed on-line. However, in many cases, the digital information can also be distributed off-line through such recording media as a floppy disk, a compact disk (CD), a DVD-ROM (Digital Versatile Disk Read Only Memory), a Zip disk, a laser disk , a videocassette tape, and/or any other type of media. Even in the case where the digital information is distributed off-line, the user application tool 214 can create the unique user key and determine whether to reproduce the information according to the created unique user key when the user first opens or reproduces the information using his terminal (or computer). Even when the user leaks out the company information by downloading the file using the recording media, it is possible to read, edit, store and print the company documents by only the user application tool 214 installed in the user terminal, preventing leakage of the company document information through the recording media.

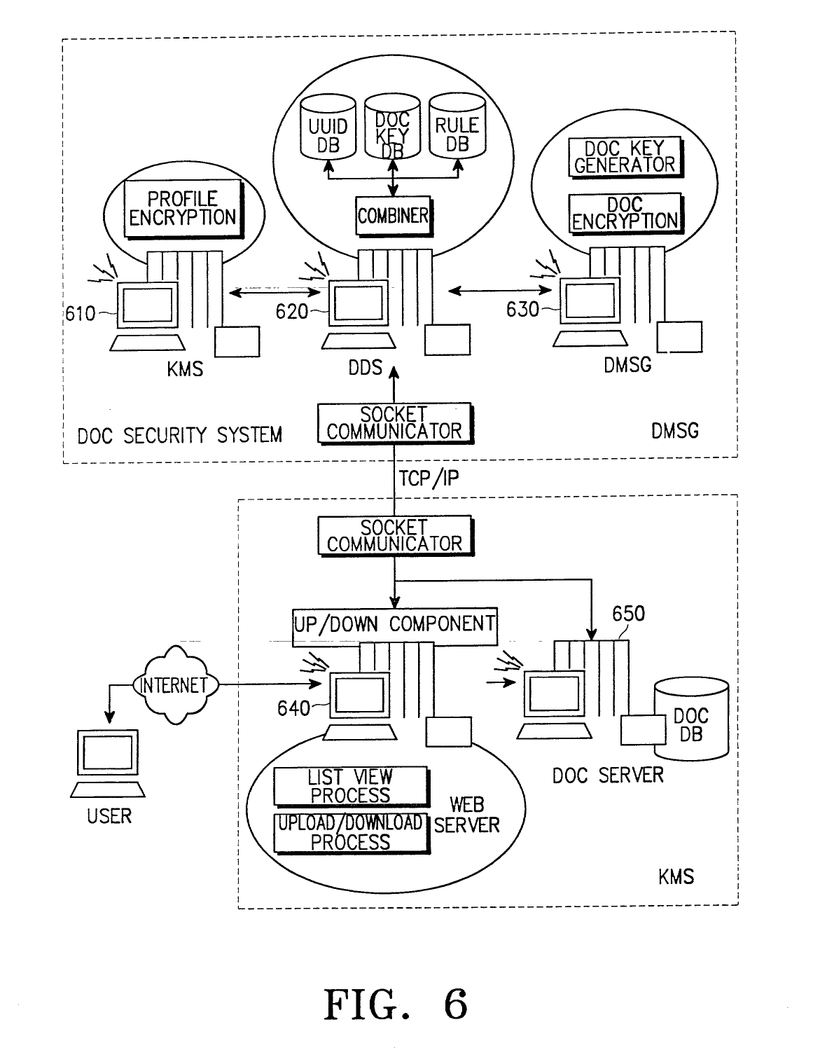

FIG. 6 illustrates an overall structure of a digital information security system according to an embodiment of the present invention. Unlike the embodiment shown in FIG. 2, the digital information security system shown in FIG. 6 and a web server are separated and these are connected through socket communication. Here, the web server can be part of a knowledge management system (KMS) or a document management system (DMS).

Referring to FIG. 6, the digital information security system includes a key management service (KMS) 610 which is not a common knowledge management system module, a document distribution service (DDS) module 620, a document management service gateway (DMSG) 630, and a web server 640 for upload/download process, which is included in a document management system (DMS) or a knowledge management system-(KMS).

The KMS module 610 is a service module for managing user information and a unique user ID (UUID). The unique user ID is created based on the unique system information of the user terminal, described with reference to FIGS. 1 to 5.

The DDS module 620 operates when the user downloads the files. The DDS module 620 creates encrypted files including information on an output rule of the corresponding files in various user environments such as user authorities, including a print authority, a save authority and a copy authority.

The DMSG 630 operates when the user uploads the files to the knowledge management system (KMS) or the document management system (DMS). The DMSG 630 creates document keys for the respective documents and encrypts the files using the created document keys.

The web server 640 included in the knowledge management system (KMS) or the document management system (DMS), transmits information on the files uploaded by the user to the DMSG 630 during an upload process. In addition, during a download process, the web server 640 transmits information on a specific file requested by the user to the DDS module 620. In the following description, an upload/download function-related process, a general function of the web server 640, will be referred to as an “upload/download process”, and a function block for performing the upload/download function-related process according to the present invention will be referred to as an “upload/download processor”.

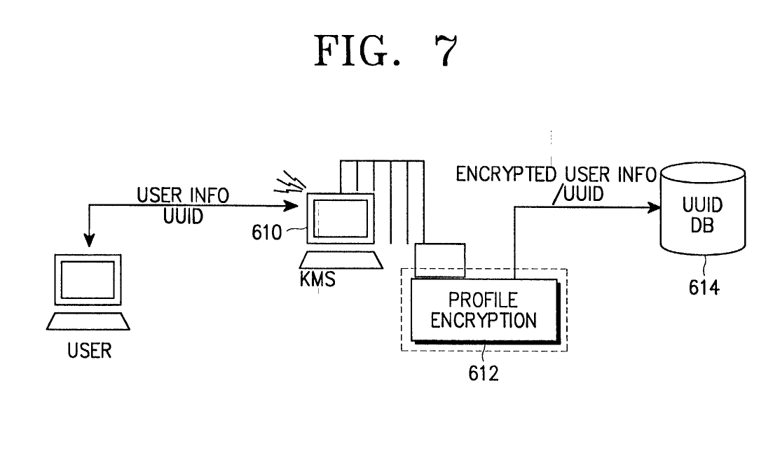

FIG. 7 is a diagram illustrating an operation of the KMS module 610 shown in FIG. 6. The KMS module 610 is a module for managing the user information and the unique user ID (UUID). The unique user ID (the same concept to “unique user key”) is created based on the system information of the corresponding user by the user application tool 214 installed in the user system (or terminal) 14 during initial user registration, and the web server 640 encrypts the files using the created unique user ID and then provides the encrypted files to the user. Since the unique user ID is unique system information, it cannot be identical to unique user IDs of other users. The user application tool 214 installed in the user terminal 14 retransmits the user information and the unique user ID to the KMS module 610 during initial installation and system upgrade.

Referring to FIG. 7, the information transmitted by the user is encrypted by a profile encryption unit 612, a 128-bit NIST (National Institute of Standards, Gaithersburg, Md. 20899-0001, USA)-authorized encryption module, under the control of the KMS module 610, and then, stored in a UUID DB 614. Therefore, even though the user information and the unique user ID are leaked out, the information cannot be interpreted.

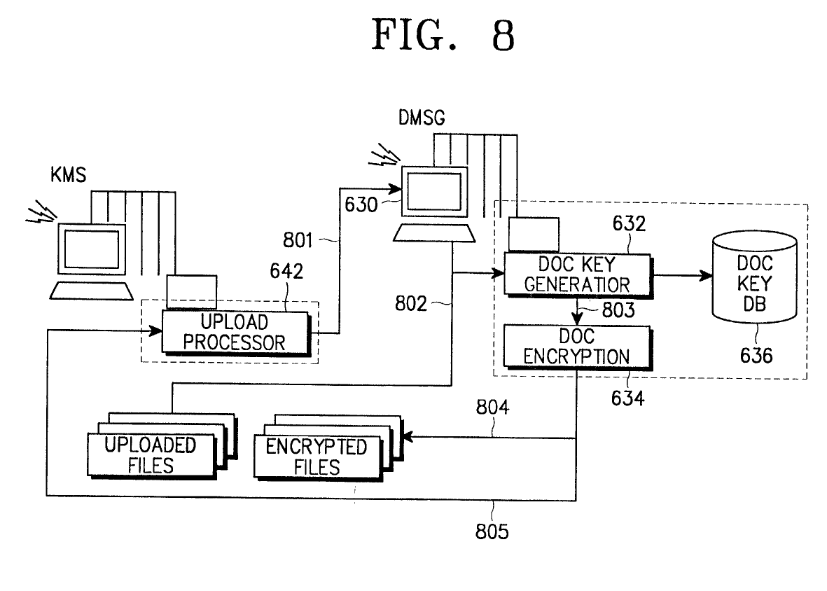

FIG. 8 is a diagram illustrating an operation of the DMSG 630 shown in FIG. 6. Referring to FIG. 8, the DMSG 630 is a service module used for real-time document encryption and management when a security-requiring file is uploaded from the user. The DMSG 630 is designed to transmit data through TCP/IP so that it is freely interlinked with the server controller 130 and the data storage unit 140, and operates in an upload process where a simple system file and a DLL (Dynamic Link Library) file are provided from the server 10.

An operation of the DMSG 630 is described below. In step 801, the DMSG 630 receives information on a file uploaded by an upload processor 642 of the web server 640 included in the KMS or the DMS, through TCP/IP. In step 802, the DMSG 630 reads the uploaded file by accessing the position where the file is actually uploaded, depending on the provided information, and provides the read file to a document key generator 632. The document key generator 632, a module for creating separate keys for the respective documents, creates a 128-bit encryption key and stores the created encryption key in a document key DB 636 together with the associated document information. In step 803, a document encryption unit 634 encrypts the corresponding document using the document key generated by the document key generator 632. The reason for previously encrypting the documents is (1) to minimize a system load due to the encryption during download of the documents by the user, (2) to maximize a processing speed by omitting the encryption process on the documents, and (3) to maintain the security of the documents even though they are distributed purposely or mistakenly. In step 804, the document encryption unit 634 stores the encrypted document in a designated folder of the encrypted document DB 145. In step 805, the document encryption unit 634 informs the KMS or the DMS that encryption of the file uploaded from the user is completed.

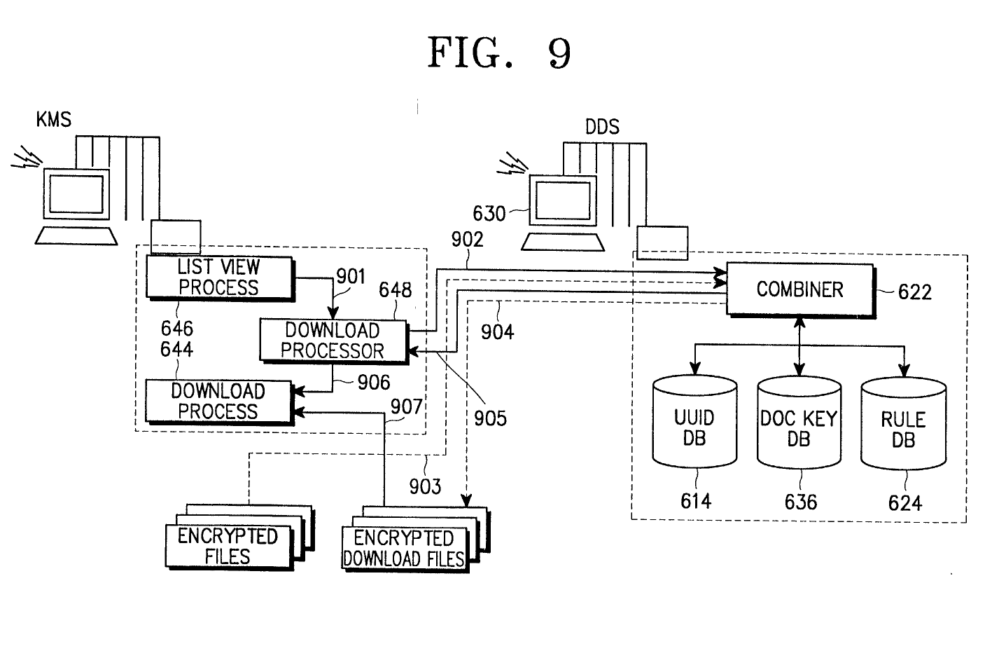

FIG. 9 is a diagram illustrating an operation of the DDS module 620 shown in FIG. 6. A list view process 646 is a process for enabling the user to view a list of files to be downloaded from the KMS or the DMS. In step 901, the list view process 646 provides a download processor 648 with information on a specific file selected by the user. After collecting the information on the selected file, the download processor 648 transmits the information to the DDS module 620 using the TCP/IP communication in step 902. A combiner 622 in the DDS module 620 physically accesses the encrypted document based on the provided information in step 903, and creates an encrypted download file matched with a user authority by reading information from the UUID DB 614, the document key DB 636 and the rule DB 624 in the user application tool 214. In step 904, the combiner 622 stores the encrypted download document file in a download position. After storing the document file, the combiner 622 informs in step 905 the download processor 648 that the download operation of the download processor 648 is completed. In step 906, the download processor 648 transfers the operation to a download process 644 of the KMS or the DMS. In step 907, the download process 644 is provided with the encrypted download file and actually downloads the file to the user.

Many companies and public institutions have replaced existing client/server systems with web-based systems. An application program supporting a web interface is easy to maintain because it is not necessary to install a separate program or upgrade the program. In addition, the application program supporting the web interface is advantageous in that it can manage the system anytime and anyplace. Similarly, the digital information security system described herein may be configured to access the user management tool 132 shown in FIG. 2 and in FIG. 6 through a web interface.

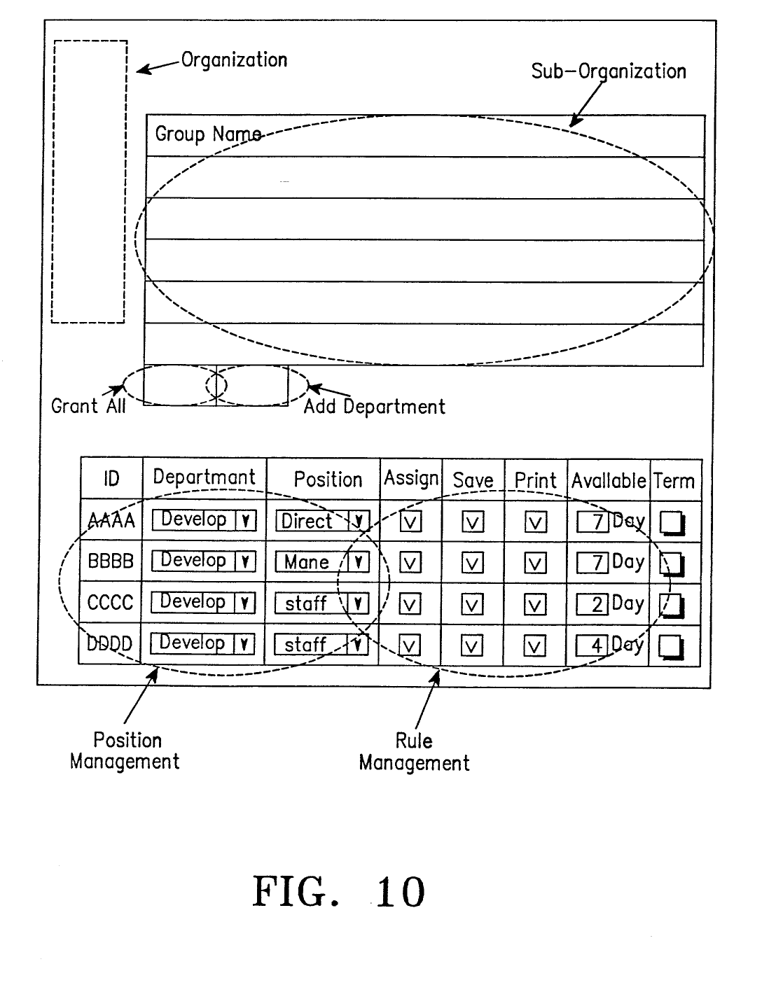

FIG. 10 illustrates an exemplary operator interface screen displayed by the user management tool 132 in the digital information security system according to an embodiment of the present invention. Referring to FIG. 10, the operator interface screen includes a department management section for inputting/outputting IDs, departments and positions of the respective users, a rule management section for inputting/outputting rules and authorities of the respective users, a general organization management section indicating the general department organization in a tree structure, and a sub-organization management section indicating a sub-organization belonging to a specific group, in the form of a text window. The operator interface screen further includes an all-authority button for-vesting every person in a certain department with all the authorities, and a department addition button for adding a specific department.

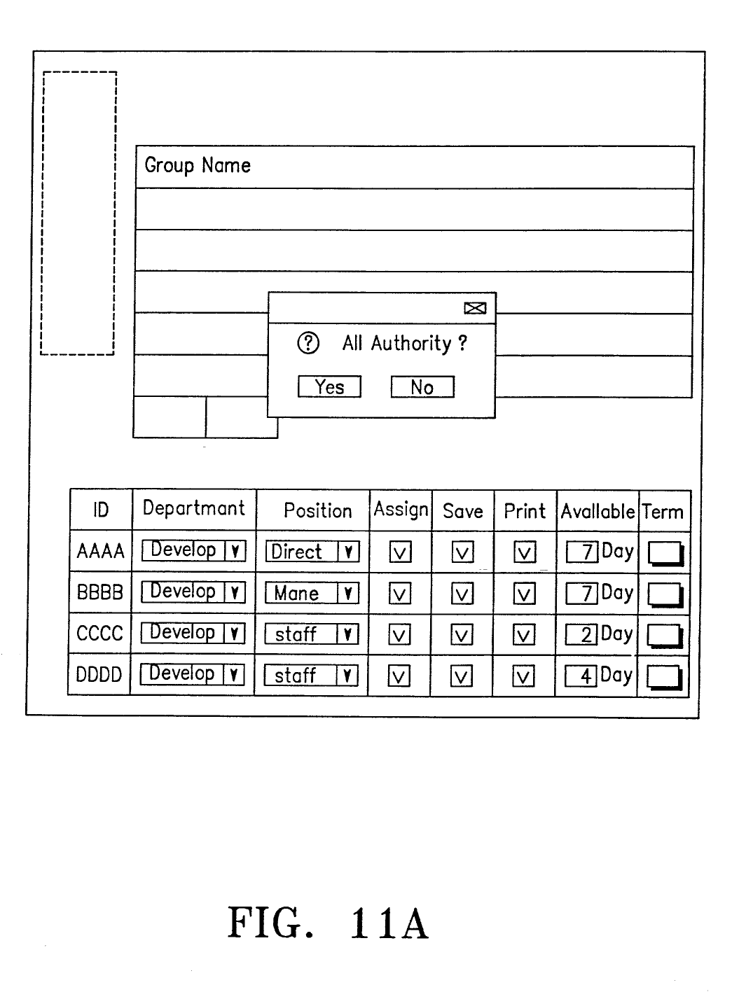

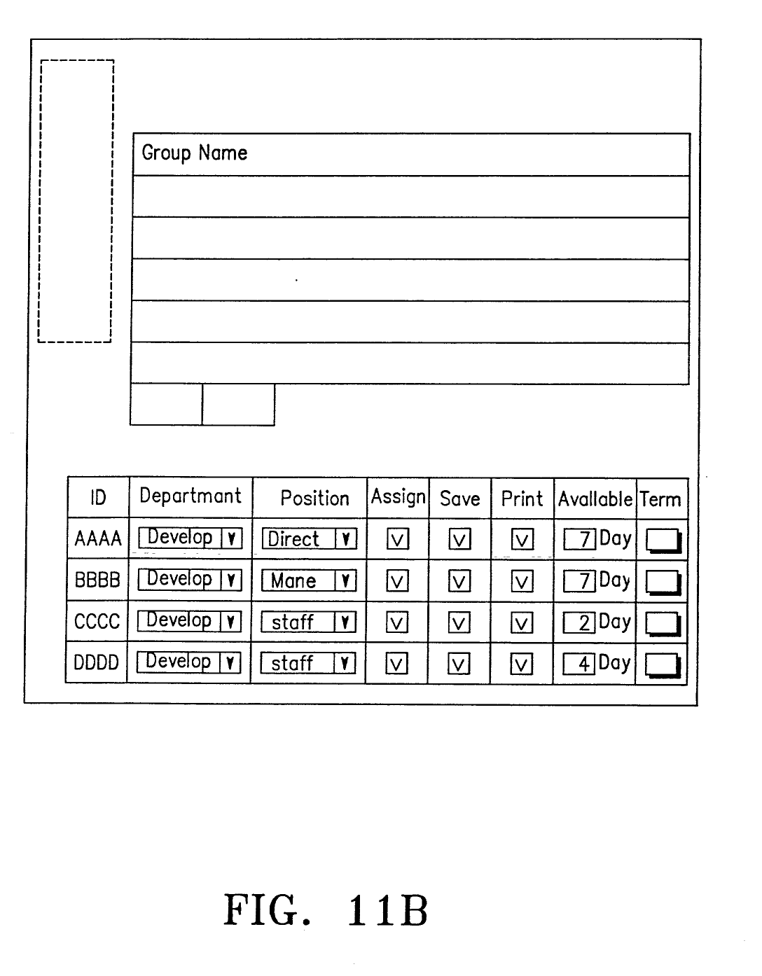

FIG. 11A illustrates an exemplary screen for vesting every user in a certain department with all the authorities in the management tool interface screen of FIG. 10, and FIG. 11B illustrates an exemplary screen displaying a state where every user in the certain department is vested with all the authorities. Referring to FIGS. 11A and 11B, if an operator clicks the all-authority button on the screen of FIG. 10, the input window of FIG. 11A is displayed. When the operator clicks an OK button on the input window, the screen of FIG. 11B is displayed, indicating a state where every user in a certain department is vested with all the authorities. In this case, all the authorities are marked by “√38 in the rule management section.

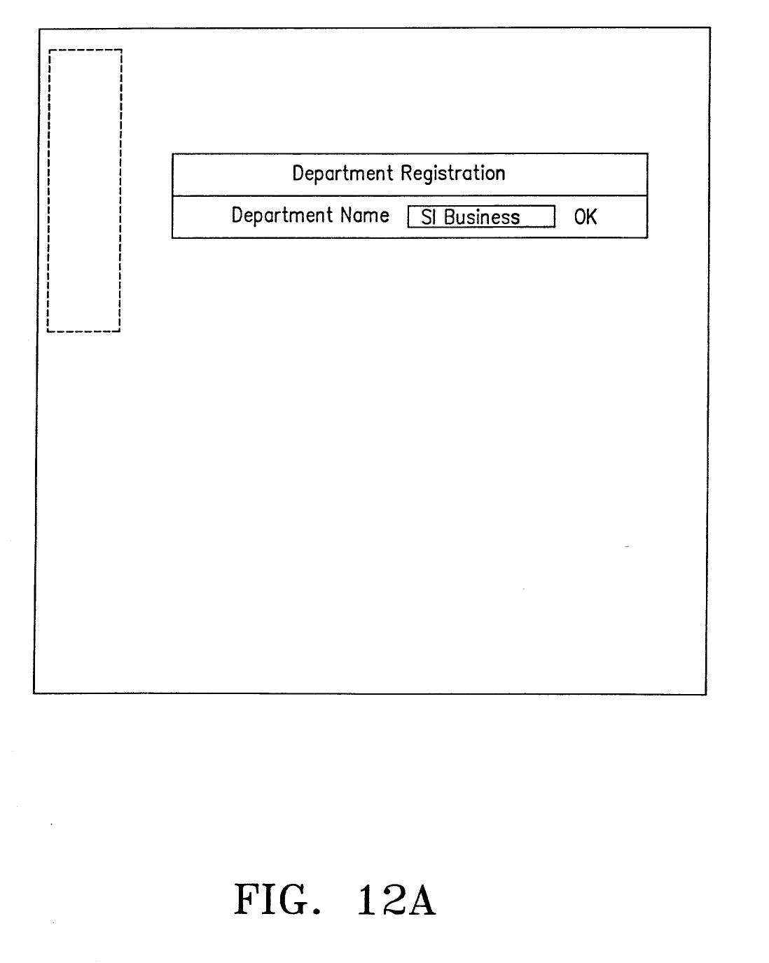

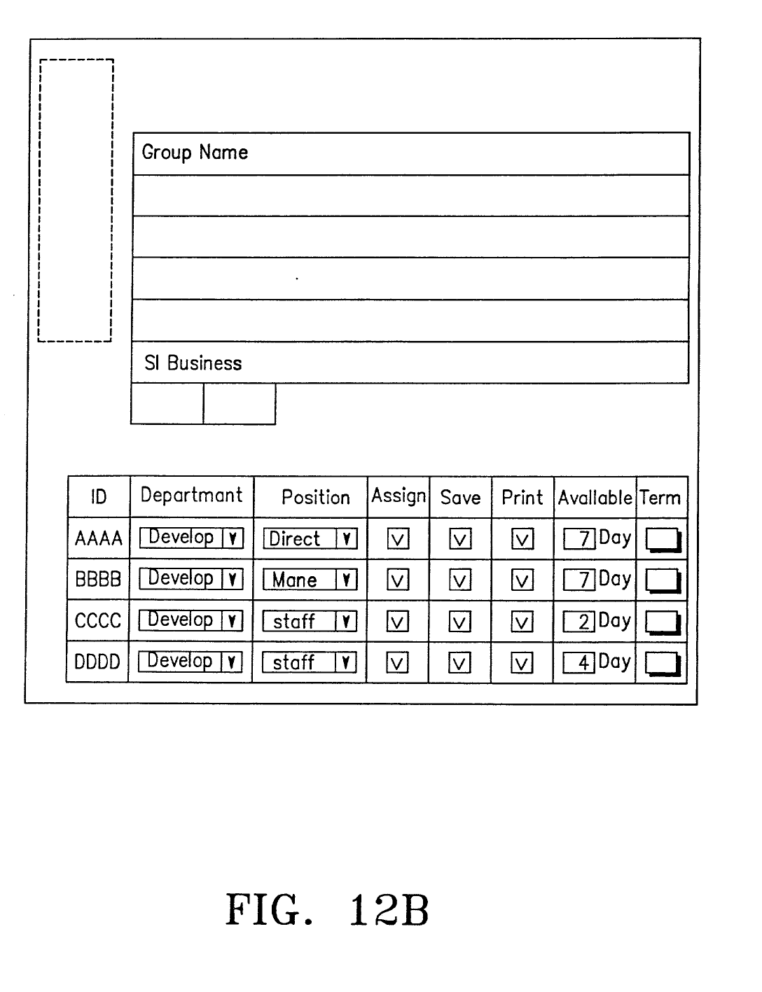

FIG. 12A illustrates an exemplary screen for adding a new department in the management tool interface screen of FIG. 10, and FIG. 12B illustrates an exemplary screen displaying a state where a new department is added in the management tool interface screen of FIG. 10. Referring to FIGS. 12A and 12B, if the operator clicks the department addition button on the screen of FIG. 10, an input window for inputting a department name is displayed. For example, FIG. 12A shows a state where a department name “SI business department” is input as an additional department, and FIG. 12B shows a state where “SI business department” is added to a specific line of the sub-organization section as a sub-folder of the general organization management section having a tree structure.

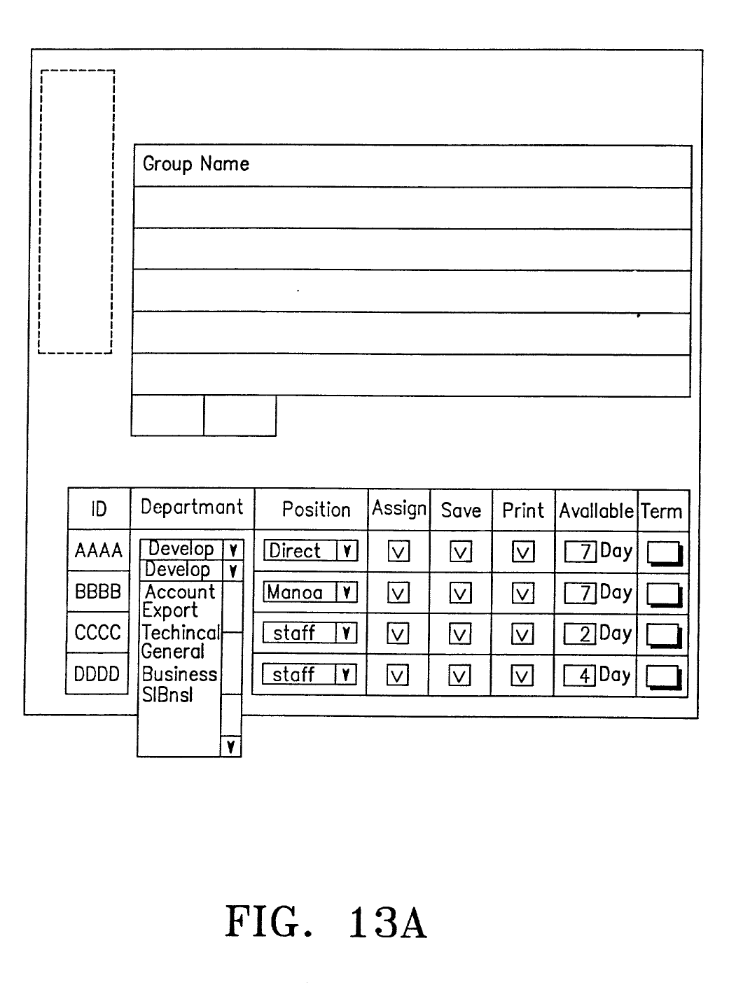

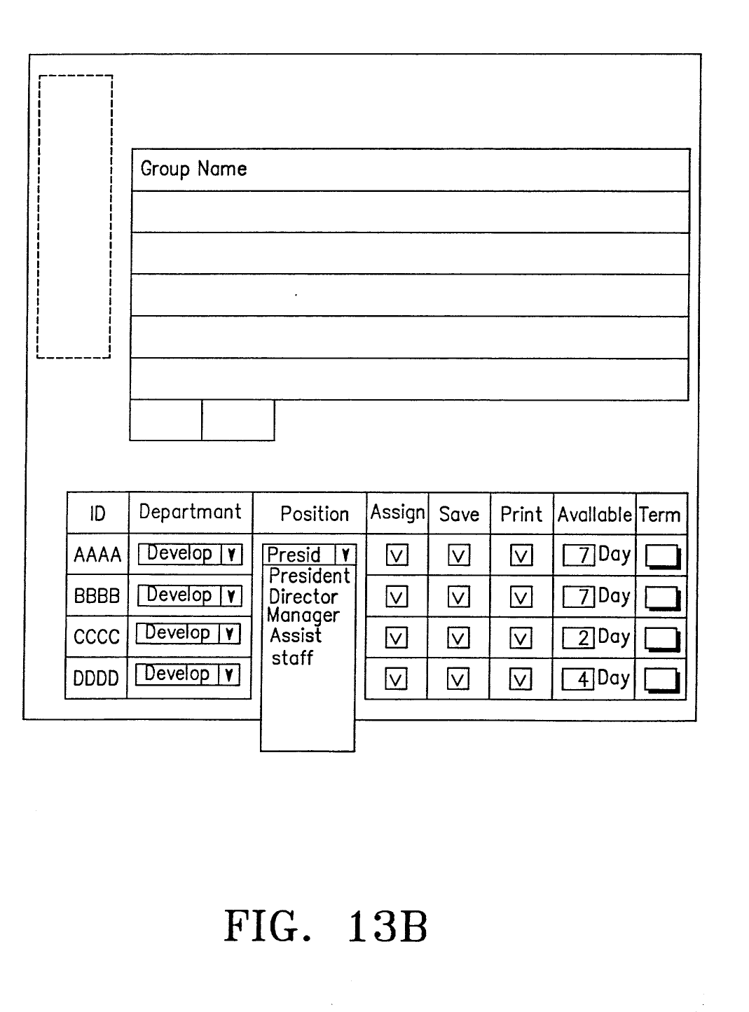

FIG. 13A illustrates an exemplary screen for changing user information of a specific user in the management tool interface screen of FIG. 10, and FIG. 13B illustrates another exemplary screen for changing user information of a specific user in the management tool interface screen of FIG. 10. Referring to FIG. 13A and 13B, the user department management section of FIG. 10 can be comprised of a section for inputting departments and positions of the respective users. In this case, the operator can change the department names by clicking department sections of the respective users as shown in FIG. 13A, or change the positions of the users by clicking position sections as shown in FIG. 13B. Through the change in the departments and the positions by the operator, the user can view only the documents of his department or set a document access authority according to the positions.

The rules established by the rule management section shown in FIG. 10 preferably include the following rules.

1) Save Authority

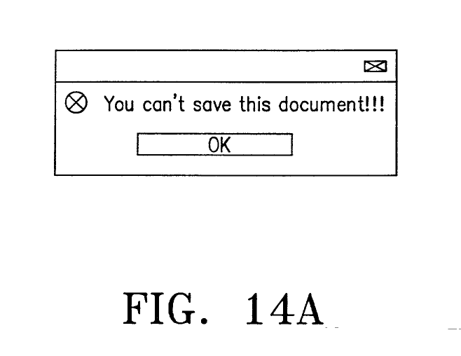

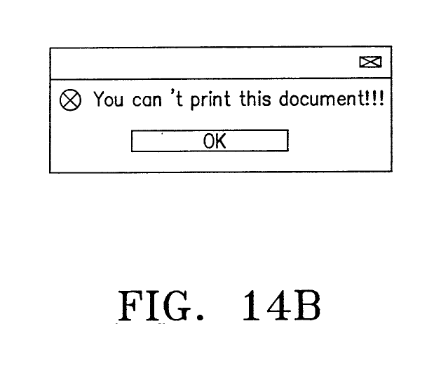

The save authority indicates an authority to save a downloaded file in the user terminal in the original file format. The user can save the downloaded file as either a normal document or an encrypted document. FIG. 14A illustrates an exemplary output screen displayed when a user who does not have document save authority attempts to save a document.

2) Print Authority

The print authority indicates an authority to print the downloaded file and to designate the number of printings. This authority controls an output matter using a printer, which should be managed in the company except for distribution of the electronic data. Such an output matter can be readily copied and distributed to others. To prevent this, the system designates and manages information on the possibility of printing and/or the number of printings. FIG. 14B illustrates an exemplary output screen displayed when a user who does not have print authority attempts to print a document.

3) Available Term Authority

The available term authority indicates an available term in which the downloaded file can be used. The available term authority can be added to the downloaded document, so that the documents whose available term has expired should be automatically discarded. A document discarding point is embodied when the management tool interface screen is customized depending on the business characteristics of the company.

4) Assignment Authority

The assignment authority indicates an authority to transfer a downloaded file to others. A user having assignment authority can assign a downloaded document to others in several ways. The other party can inform the user having the authority of this information, so that the system can operate without intervention of a separate management tool interface and can be normally connected to the management tool interface during assignment. This part may also be customized depending on the policy of the company.

Such authorities are vested to the users by the operator as stated above. Actually, vesting the authority to the users in the company is a heavy burden for the manager, and frequent changes of the manager between organizations make it difficult to perform proper personal management. To solve this problem, it is possible to change the user-based rule restriction to the document class-based rule restriction. That is, by supporting outputting (e.g., printing) and saving according to the security class of the documents, it is possible to minimize interventions of the managers.

By doing so, the digital information security system according to the present invention can copy and output the downloaded document and also distribute the downloaded document to others according to the user authorities. Such user authorities can be processed in connection with a user access control rule of the existing KMS or EDMS (Enterprise Document Management System) system. Alternatively, a separate rule database can be constructed for the user authorities.

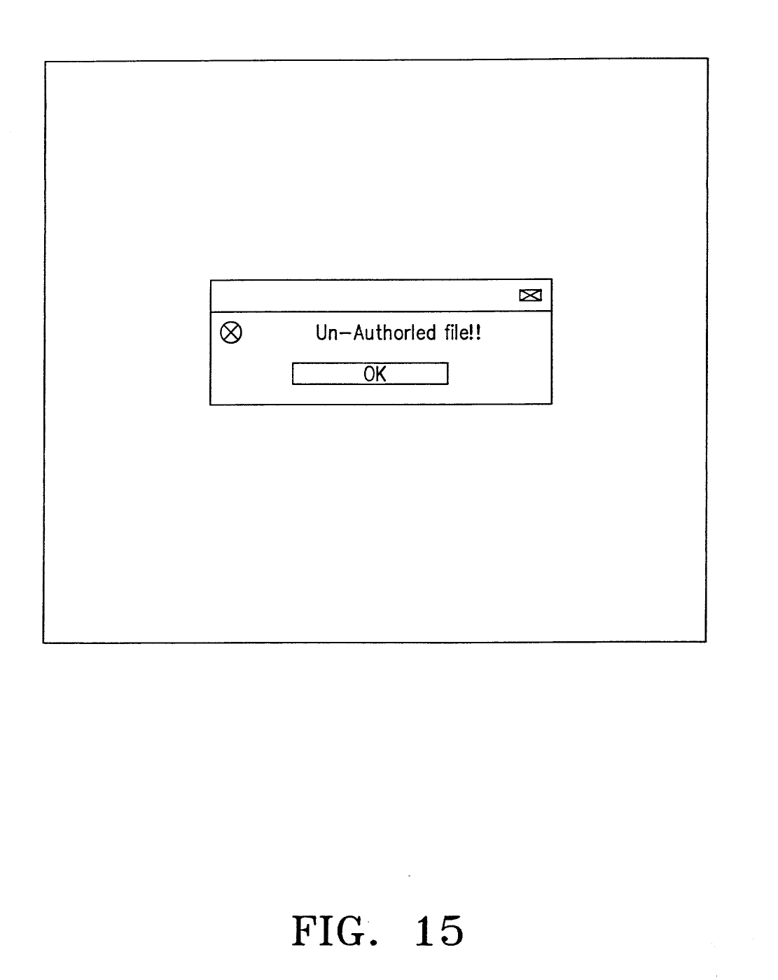

As stated above, the digital information security system described herein preferably maintains the security of the source documents stored in the existing KMS or DMS, using an NIST-authorized encryption algorithm, and vests the user with an authority to open documents when he downloads the documents, thereby radically preventing leakage of the documents. In addition, when an unregistered user opens the downloaded file, it appears in a meaningless format. If the downloaded file is transferred to another user in the company, it cannot be opened unless trust relationship is established between them. FIG. 15 illustrates an exemplary screen displayed when a file downloaded according to the present invention is copied or opened in another system.

The general DRM system or document security management system preferably manages the encrypted documents using a separate application program. In this case, if a document file format is added or upgraded, it may be necessary to make and distribute a separate document viewer, and the client may need to install the program in his terminal. Recently, however, the viewer for the file upgraded by the DRM maker is not distributed promptly, because the file format is complicated.

The document viewer module described herein is preferably installed in the user application tool 214, and is designed to call a document edition programs such as MS-OFFICE, so that the users can view the documents using the word processor without a separate viewer program and plug-in program. That is, the document viewer module calls the document edition program and outputs the called document edition program to a specific window, so that the user can view or edit the document using the document edition program. In this case, the user executes the documents edition program without running the document viewer module. The document viewer module determines whether to execute the save or print operation according to the rule and the user information, under a restriction command preset for document security, such as save and print of a file downloaded during execution of the document edition program.

In the existing digital information security system supporting a plug-in application program, the digital information security system supplier must make and distribute a new plug-in program each time the application program is upgraded. However, when using the document viewer described herein, the user can simply upgrade his application program, making it easy to maintain the system.

The digital information security system described herein can not only prevent illegal distribution of the confidential company information, but can also prevent leakage of the company information while guaranteeing free exchanges of the information in the company, by interlinking the system with the general KMS constructed for restriction of users and for information sharing. In addition, even a company not having the KMS system can prevent the leakage of the company documents using the novel system through the LAN or WAN. Further, the user cannot leak out the company documents through the recording media, because every user terminal has a different unique user key. In addition, even when the company document DB is externally hacked by a hacker, the hacked documents are useless because the documents are encrypted.

While the invention has been described with reference to a certain embodiments, it will be understood by those skilled in the art that various changes in form and details may be made therein without departing from the spirit and scope of the invention as defined by the appended claims.

What is claimed is:

1. A digital information security system comprising:
a user application tool installed in a user terminal, the user application tool being structured to create a unique user key using unique system information of the user terminal;
a data storage unit for storing user information and digital information; and
a user management tool installed in a server, the user management tool being structured to receive the unique user key created by the user application tool, the user management tool being structured to store the received unique user key in the data storage unit, the user management tool being structured to compare the stored unique user key with a unique user key provided from the user application tool of a user currently being subjected to authentication.

2. The digital information security system as claimed in claim 1, further comprising a history manager for managing user access and use history.

3. The digital information security system as claimed in claim 1, wherein the unique system information includes at least one of unique CPU (Central Processing Unit) information, unique HDD (Hard Disk Drive) information, and serial number information of the user terminal.

4. The digital information security system as claimed in claim 1, further comprising a rule establishing unit for establishing a established rule according to a user rule previously established for the stored digital information, wherein the user application tool transmits information on the user rule during download of the digital information to the user, wherein upon downloading the digital information, the user application tool determines whether to output the downloaded digital information according to the established rule.

5. The digital information security system as claimed in claim 4, wherein said digital information includes an encrypted user requested digital file and a digital file decoding key using said unique user key and said rule information.

6. A digital information security method comprising:
reading a first unique user key created using unique system information of a user terminal when a sever is accessed by a user;
comparing the first unique user key with a second unique user key included in previously stored user information for the user, to authenticate whether the user is an authorized user;
encrypting a file uploaded by the authorized user using a preset encryption key, and storing the encrypted file as digital information; and
encrypting a decoding key for the corresponding digital information using the second unique user key included in the user information, and downloading the encrypted decoding key along with the associated digital information in response to a digital information download request of the authorized user.

7. The digital information security method as claimed in claim 6, further comprising the step of decoding the digital information by decoding the encrypted decoding key for the digital information downloaded from the user terminal using the first unique user key created from the unique system information,

8. The digital information security method as claimed in claim 6, wherein the downloading includes said encrypted digital file and said decoding key of said encrypted digital file and rule information on use authority.

9. The digital information security method as claimed in claim 6, further comprising:
transmitting to the user a program for creating and transmitting the first unique user key using the unique system information of the user terminal when the user is unregistered, so as to allow the user to install the program in the user terminal; and
registering by the installed program the corresponding user using the first unique user key.

10. A digital information security method comprising the steps of:
creating a unique user key at a user terminal using unique system information of the user terminal;
decoding an encrypted decoding key included in the digital information at the user terminal using the created unique user key; and
decoding the digital information using the decoded decoding key, wherein the encrypted decoding key cannot be decoded when the key used for decoding the encrypted decoding key is not identical to the created unique user key.

11. A digital information security system comprising:
a key management service module installed in a user system, the key management service module being structured to encrypt user information including a unique user ID created based on system information of a corresponding user from a user application tool installed in a system of the user, and storing the encrypted user information;
a document management service gateway structured to create a document key for the file when a file is uploaded from the user store the created document key, and encryp a corresponding file using the created document key;
a document distribution service module structured to create an encrypted download file including information on an output rule of the file in a predetermined user environment when downloading the file to the user; and
a web server structured to transmit information on the file uploaded through the Internet by the user to the document management service gateway so that the document management service gateway encrypts the file, and transmitt, upon receipt of a file download request from the user, information on the request to the document distribution service module so that the document distribution service module creates an encrypted download file for the file.

12. The digital information security system as claimed in claim 11, wherein the user application tool is structured to create the unique user ID and transmit the user information during initial installation and upgrade of the user system.

13. The digital information security system as claimed in claim 11, wherein the user application tool includes a document viewer module structured to call a plurality of document edition software programs, output the called programs in a predetermined window, and allow the user to execute the document edition software programs.

14. The digital information security system as claimed in claim 13, wherein the document viewer module is structured to allow the user to execute the document edition software program on the window, and determine whether to perform a predetermined execution control operation including an operation of saving and printing a predetermined file according to predetermined rule information and user information for the file downloaded during execution of the document edition software program.

15. The digital information security system as claimed in claim 11, wherein communication among the document key management service module, the document management service gate, the document distribution service module and the web server is performed through TCP/IP (Transmission Control Protocol/Internet Protocol).

16. A digital information security method in a digital information security system including a documents key management service module for managing user information including a unique user ID created based on system information of a user, a document management service gateway for encrypting a corresponding file by creating a document key for an uploaded file, a document distribution service module for creating an encrypted download file including information on an output rule of a file to be downloaded, and a web server for performing a file uploading/download operation with the user through the Internet, transmitting information on an uploaded file to the document management service gateway and transmitting information on a download request to the document distribution service module, the method comprising the steps of:
transmitting by the web server information on the uploaded file to the document management service gateway;
reading by the document management service gateway the uploaded file by accessing a position where the file is actually uploaded from the server, using the information on the uploaded file;
creating a document key for the read file in a predetermined decoding method, and storing the created document key along with the corresponding file information;
encrypting the file using the created document key;
storing the encrypted file in a predetermined folder; and
informing the web server that processing the uploaded file is completed.

17. The digital information security method as claimed in claim 16, further comprising the steps of:
upon receipt of a file download request, transmitting by the web server information on a download-requested file to the document distribution service module;
accessing by the document distribution service module a corresponding encrypted file using the information on the download-requested file;
creating an encrypted download document file matched with an authority of the user based on user information of the user and information on the document key for the document and the output rule;
storing the created encrypted download file in a download position; and
informing the web server that processing the download-requested file is completed.

18. The digital information security method as claimed in claim 16, wherein the information on the output rule includes a save authority which is a rule indicating whether the user can save the download document file in a user terminal of the user, a print authority which is a rule indicating possibility and number of printing the download document file, an available term authority indicating a rule for an available term of the download document file, and an assignment authority indicating a rule for assignment of the download document file.

19. The digital information security method as claimed in claimed 17, said creating an encrypted download document file includes combining said rule information on said authority with said decoding key of said encrypted file and encrypting said rule information and said decoding key using said unique user ID and combining combined said rule information and decoding key with said encrypted download document file.
